(19) United States
(12) Patent Application Publication
(10) Pub. No.: US 2013/0061071 A1
(43) Pub. Date: Mar. 7, 2013

(54) Energy Efficient Implementation Of Read-Copy Update For Light Workloads Running On Systems With Many Processors

(71) Applicant: Paul E. McKenney, Beaverton, OR (US)

(72) Inventor: Paul E. McKenney, Beaverton, OR (US)

(73) Assignee: INTERNATIONAL BUSINESS MACHINES CORPORATION, Armonk, NY (US)

(21) Appl. No.: 13/225,425

(22) Filed: Sep. 3, 2011

(51) Int. Cl. G06F 1/32

(52) U.S. Cl. 713/320

(57) ABSTRACT

A technique for determining if a processor in a multiprocessor system implementing a read-copy update (RCU) subsystem may be placed in low power state. The technique may include determining whether the processor has any RCU callbacks that are ready for invocation or the RCU subsystem requires grace period advancement processing from the processor. The processor may be placed in a low power state if either (1) a first condition holds wherein the processor has one or more pending RCU callbacks, but does not have any RCU callbacks that are ready for invocation and the RCU subsystem does not require grace period advancement processing from the processor, (2) a second condition holds wherein the processor does not have any pending RCU callbacks.

### BACKGROUND

1. Field

The present disclosure relates to computer systems and methods in which data resources are shared among data consumers while preserving data integrity and consistency relative to each consumer. More particularly, the disclosure concerns an implementation of a mutual exclusion mechanism known as “read-copy update” in a computing environment wherein processors that need to perform callback processing are capable of assuming low power states.

2. Description of the Prior Art

By way of background, read-copy update (also known as “RCU”) is a mutual exclusion technique that permits shared data to be accessed for reading without the use of locks, writes to shared memory, memory barriers, atomic instructions, or other computationally expensive synchronization mechanisms, while still permitting the data to be updated (modify, delete, insert, etc.) concurrently. The technique is well suited to both uniprocessor and multiprocessor computing environments wherein the number of read operations (readers) accessing a shared data set is large in comparison to the number of update operations (updaters), and wherein the overhead cost of employing other mutual exclusion techniques (such as locks) for each read operation would be high. By way of example, a network routing table that is updated at most once every few minutes but searched many thousands of times per second is a case where read-side lock acquisition would be quite burdensome.

The read-copy update technique implements data updates in two phases. In the first (initial update) phase, the actual data update is carried out in a manner that temporarily preserves two views of the data being updated. One view is the old (pre-update) data state that is maintained for the benefit of read operations that may have been referencing the data concurrently with the update. The other view is the new (post-update) data state that is seen by operations that access the data following the update. In the second (deferred update) phase, the old data state is removed following a “grace period” that is long enough to ensure that the first group of read operations will no longer maintain references to the pre-update data. The second-phase update operation typically comprises freeing a stale data element to reclaim its memory. In certain RCU implementations, the second-phase update operation may comprise something else, such as changing an operational state according to the first-phase update.

FIGS. 1A-1D illustrate the use of read-copy update to modify a data element B in a group of data elements A, B and C. The data elements A, B, and C are arranged in a singly-linked list that is traversed in acyclic fashion, with each element containing a pointer to a next element in the list (or a NULL pointer for the last element) in addition to storing some item of data. A global pointer (not shown) is assumed to point to data element A, the first member of the list. Persons skilled in the art will appreciate that the data elements A, B and C can be implemented using any of a variety of conventional programming constructs, including but not limited to, data structures defined by C-language “struct” variables. Moreover, the list itself is a type of data structure.

It is assumed that the data element list of FIGS. 1A-1D is traversed (without locking) by multiple readers and occasionally updated by updaters that delete, insert or modify data elements in the list. In FIG. 1A, the data element B is being referenced by a reader r1, as shown by the vertical arrow below the data element. In FIG. 1B, an updater u1 wishes to update the linked list by modifying data element B. Instead of simply updating this data element without regard to the fact that r1 is referencing it (which might crash r1), u1 preserves B while generating an updated version thereof (shown in FIG. 1C as data element B′) and inserting it into the linked list. This is done by u1 acquiring an appropriate lock (to exclude other updaters), allocating new memory for B′, copying the contents of B to B′, modifying B′ as needed, updating the pointer from A to B so that it points to B′, and releasing the lock. In current versions of the Linux® kernel, pointer updates performed by updaters can be implemented using the rcu_assign_pointer( ) primitive. As an alternative to locking during the update operation, other techniques such as non-blocking synchronization or a designated update thread could be used to serialize data updates. All subsequent (post update) readers that traverse the linked list, such as the reader r2, will see the effect of the update operation by encountering B′ as they dereference B's pointer. On the other hand, the old reader r1 will be unaffected because the original version of B and its pointer to C are retained. Although r1 will now be reading stale data, there are many cases where this can be tolerated, such as when data elements track the state of components external to the computer system (e.g., network connectivity) and must tolerate old data because of communication delays. In current versions of the Linux® kernel, pointer dereferences performed by readers can be implemented using the rcu_dereference( ) primitive.

At some subsequent time following the update, r1 will have continued its traversal of the linked list and moved its reference off of B. In addition, there will be a time at which no other reader process is entitled to access B. It is at this point, representing an expiration of the grace period referred to above, that u1 can free B, as shown in FIG. 1D.

FIGS. 2A-2C illustrate the use of read-copy update to delete a data element B in a singly-linked list of data elements A, B and C. As shown in FIG. 2A, a reader r1 is assumed be currently referencing B and an updater u1 wishes to delete B. As shown in FIG. 2B, the updater u1 updates the pointer from A to B so that A now points to C. In this way, r1 is not disturbed but a subsequent reader r2 sees the effect of the deletion. As shown in FIG. 2C, r1 will subsequently move its reference off of B, allowing B to be freed following the expiration of a grace period.

In the context of the read-copy update mechanism, a grace period represents the point at which all running tasks (e.g., processes, threads or other work) having access to a data element guarded by read-copy update have passed through a “quiescent state” in which they can no longer maintain references to the data element, assert locks thereon, or make any assumptions about data element state. By convention, for operating system kernel code paths, a context switch, an idle loop, and user mode execution all represent quiescent states for any given CPU running non-preemptible code (as can other operations that will not be listed here). The reason for this is that a non-preemptible kernel will always complete a particular operation (e.g., servicing a system call while running in process context) prior to a context switch.

In FIG. 3, four tasks 0, 1, 2, and 3 running on four separate CPUs are shown to pass periodically through quiescent states (represented by the double vertical bars). The grace period (shown by the dotted vertical lines) encompasses the time frame in which all four tasks that began before the start of the grace period have passed through one quiescent state. If the four tasks 0, 1, 2, and 3 were reader tasks traversing the linked lists of FIGS. 1A-1D or FIGS. 2A-2C, none of these tasks having reference to the old data element B prior to the grace period could maintain a reference thereto following the grace period. All post grace period searches conducted by these tasks would bypass B by following the updated pointers created by the updater.

Grace periods may synchronous or asynchronous. According to the synchronous technique, an updater performs the first phase update operation, blocks (waits) until a grace period has completed, and then implements the second phase update operation, such as by removing stale data. According to the asynchronous technique, an updater performs the first phase update operation, specifies the second phase update operation as a callback, then resumes other processing with the knowledge that the callback will eventually be processed at the end of a grace period. Advantageously, callbacks requested by one or more updaters can be batched (e.g., on callback lists) and processed as a group at the end of an asynchronous grace period. This allows asynchronous grace period overhead to be amortized over plural deferred update operations.

More recently, RCU grace period processing has been adapted to account for processor low power states (such as, on Intel® processors, the C1E halt state, or the C2 or deeper halt states). Operating systems can take advantage of low power state capabilities by using mechanisms that withhold regular timer interrupts from processors (in a low power state) unless the processors need to wake up to perform work. The dynamic tick framework (also called “dyntick” or “nohz”) in current versions of the Linux® kernel is one such mechanism. In current RCU implementations designed for low power applications in the Linux® kernel, the scheduler places a processor in dyntick-idle mode using a function called “tick_nohz_stop_sched_tick( )” See Linux® 3.0 source code, tick_nohz_stop_sched_tick( ) function at lines 250-453 of Linux/kernel/time/tick-sched.c. Before actually changing the processor's mode, this function invokes another function called “rcu_needs_cpu( )” to check whether the processor has any callback processing work that needs to be performed, even if none needs to be done immediately. If the processor does have pending callbacks, it is not permitted to enter dyntick-idle mode. The reason for this is because grace period and callback detection processing is normally driven by the scheduling clock interrupt, and such processing will not be performed when the scheduling clock tick is suppressed. Unfortunately, keeping the processor out of dyntick-idle mode to wait for callbacks to be invoked can cause the processor to remain in a high-power mode for many milliseconds following the time its power level could have otherwise been reduced.

Current RCU implementations designed for non-preemptible versions of the Linux® kernel provide an RCU_FAST_NO_HZ configuration option. When the kernel is compiled with this option, the rcu_needs_cpu( ) function performs in the manner described above as processors are placed in dyntick-idle mode, but then implements special handling when the last remaining non-dyntick-idle processor is encountered. When the scheduler attempts to place this processor in dyntick-idle mode, the rcu_needs_cpu( ) function does several things. During an initial hold-off period, the rcu_needs_cpu( ) function performs as described above, preventing the processor from being placed in dyntick-idle mode if it has pending callbacks. Once the hold-off period is over, the rcu_needs_cpu( ) function performs callback flush processing to expedite the removal of the processor's remaining callbacks.

In particular, the rcu_needs_rcu( ) function (1) forces the RCU grace period machinery to quickly end the current grace period, (2) notes whether the processor has any pending callbacks, and if so (3) enters a softirq environment to invoke a function called “rcu_process_callbacks( )” that advances the callbacks on the callback lists and processes any that are ready to be invoked. At the end of callback processing, the rcu_process_callbacks( ) function re-invokes the rcu_needs_cpu( ) function, which then causes the rcu_process_callbacks( ) function to be re-invoked in a separate softirq context, and so on, until there are (hopefully) no callbacks. This handing off between the rcu_needs_cpu( ) function (initially called by the scheduler attempting to place a processor in dyntick-idle mode) and the rcu_process_callbacks( ) function (called within softirq context) represents a callback flush loop that is continued for a specified number of passes (e.g., five) or until all of the processor's callbacks have been processed (whichever occurs sooner).

If the callback flush operations are successful at removing all pending callbacks within a specified number of passes through the loop, the processor will be placed in dyntick-idle mode. Insofar as this processor was the last remaining non-dyntick-idle processor, all processors will now be in a low power state. If the processor's callbacks cannot be removed within the specified number of passes, the processor will remain active, but a retry can be performed at a later time. The number of passes through the callback flush loop, as well as the hold-off period that is observed before entering the loop, may be selected using per-processor state variables. See Linux® 3.0 source code, rcu_needs_cpu( ) function at lines 1170-1244 of Linux/kernel/rcutree_plugin.h.

The Linux® RCU_FAST_NO_HZ mechanism works well for small systems with few processors (e.g., <16 processors). However, larger systems (e.g., >16 processors) running with low (but not insignificant) utilization (e.g., 30% of maximum capacity) will almost never be in a state where all processors but one are in dyntick-idle mode, so that RCU_FAST_NO_HZ has no chance to help in that case. In addition, in systems running workloads that generate large numbers of RCU callbacks, the system might never have all its processors free of such callbacks, and thus never have all of its processors in dyntick-idle mode, even when all the processors are idle. It is noted that RCU_FAST_NO_HZ was designed for systems with small numbers of processors and very low utilization, as is the case for many battery-powered embedded devices.

It is to improvements in read-copy update for use in low power environments that the present disclosure is directed. What is needed is a read-copy update implementation that allows processors to enter low power states while accommodating the need to process callbacks. Other processing states wherein scheduling clock interrupts are reduced or eliminated could also benefit. For example, there has been work in the Linux® kernel community directed to permitting the scheduling clock interrupt to be turned off on non-idle processors, as long as a given processor has but one runnable task. This can reduce OS jitter and improve real-time response. See F. Weisbecker, “Nohz cpusets”, Linux kernel Mailing List, Aug. 15, 2011, available at <https://lkml.org/lkml/2011/8/15/245>. However, workloads that generate large numbers of RCU callbacks will suffer from a lack of regular scheduling clock interrupts as are needed to advance the processing of such callbacks, thus limiting the effectiveness of this technique.

### SUMMARY

A method, system and computer program product are provided for determining if a processor in a multiprocessor system implementing a read-copy update (RCU) subsystem may be placed in low power state. In an example embodiment, the disclosed technique includes determining whether the processor has any RCU callbacks that are ready for invocation or the RCU subsystem requires grace period advancement processing from the processor. The processor may be placed in a low power state if either (1) a first condition holds wherein the processor has pending RCU callbacks, but does not have any RCU callbacks that are ready for invocation and the RCU subsystem does not require grace period advancement processing from the processor, (2) a second condition holds wherein the processor does not have any pending RCU callbacks.

In an example embodiment, a callback flag may be set when placing the processor in a low power state when the first condition holds in order to note that the processor has one or more pending RCU callbacks. Callback flush loop processing may be performed to invoke or advance RCU callbacks if a third condition holds wherein the processor has one or more pending RCU callbacks and such callbacks are ready for invocation or the RCU subsystem requires grace period advancement processing from the processor. The callback flush loop processing may be repeated for a predetermined loop count or until the first or second condition is reached. If the callback flag has been set for the processor, it may be cleared once callback flush loop processing is performed and the processor has no more callbacks. When an RCU grace period ends, other processors may be checked to determine if they are in a low power state and have the callback flag set. Such processors may be awakened from their low power state so that their callbacks may be processed. The determination of whether a processor may be placed in a low power state may be performed for each processor in a multiprocessor system that is being considered for placement in a low power state.

### BRIEF DESCRIPTION OF THE DRAWINGS

The foregoing and other features and advantages will be apparent from the following more particular description of example embodiments, as illustrated in the accompanying Drawings, in which:

FIGS. 1A-1D are diagrammatic representations of a linked list of data elements undergoing a data element replacement according to a conventional read-copy update mechanism;

FIGS. 2A-2C are diagrammatic representations of a linked list of data elements undergoing a data element deletion according to a conventional read-copy update mechanism;

FIG. 3 is a flow diagram illustrating a grace period in which four processes pass through a quiescent state;

FIG. 4 is a functional block diagram showing a multiprocessor computing system that may be implemented in accordance with the present disclosure;

FIG. 5 is a functional block diagram showing an RCU subsystem that may be provided in the computer systems of FIG. 4;

FIG. 6 is a block diagram showing a set of RCU subsystem support functions that be provided by the RCU subsystem of FIG. 5;

FIG. 7 is a block diagram showing an operating system scheduler that implements a function for placing processors in a low power state;

FIG. 8 is a flow diagram showing an example callback flush component that may be provided by the RCU subsystem of FIG. 5:

FIG. 9 is a flow diagram showing an example callback handler that may be provided by the RCU subsystem shown of FIG. 5; and

FIG. 10 is a diagrammatic illustration showing example media that may be used to provide a computer program product in accordance with the present disclosure.

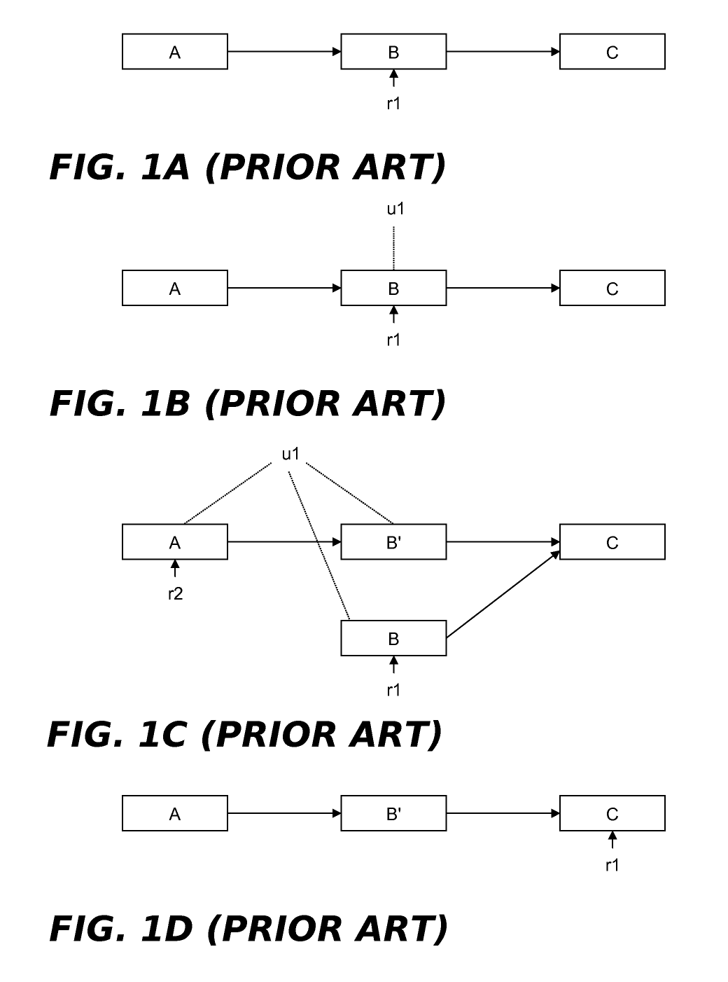

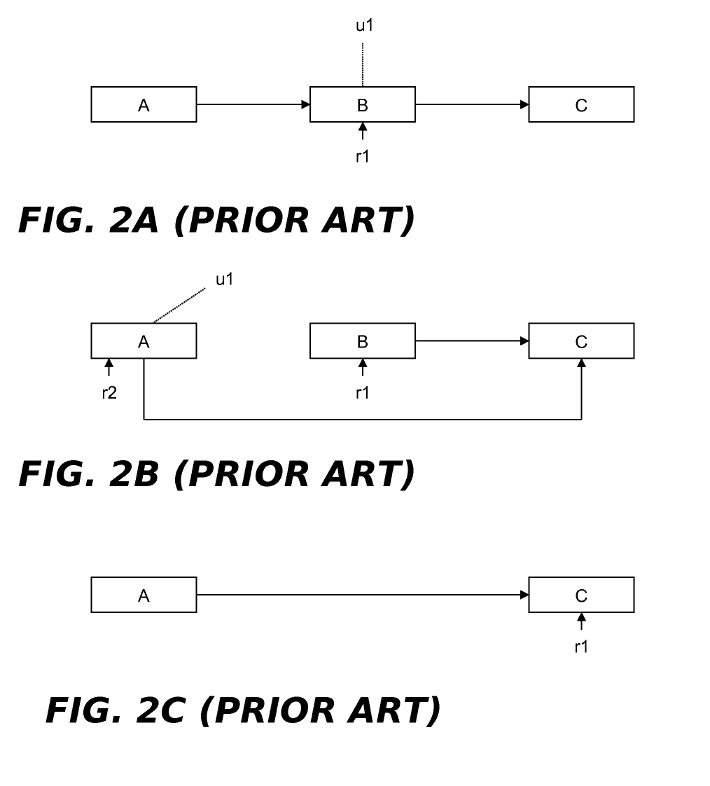

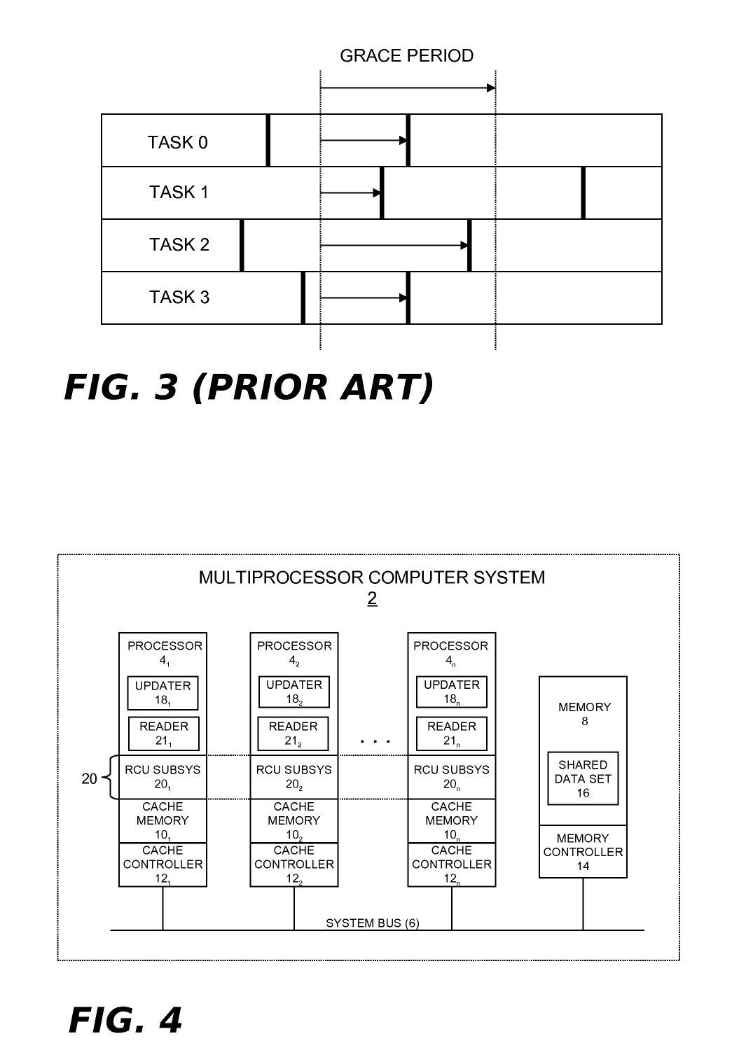

### DETAILED DESCRIPTION OF EXAMPLE EMBODIMENTS

### Introduction

The present disclosure describes a technique that improves upon the Linux® RCU_FAST_NO_HZ configuration option (described in the “Background” section above) in order to provide an energy efficient read-copy update implementation for light workloads running on systems with many processors, or for workloads that generate many RCU callbacks, or for workloads that run as single tasks on processors running for long periods without a scheduling clock interrupt. As described in more detail below in the context of an example embodiment, when an operating system scheduler attempts to place a processor in dyntick-idle mode (or some other low power state that withholds scheduling clock interrupts), the mode change will be allowed to proceed if there are no pending callbacks. This is similar to the existing Linux® RCU_FAST_NO_HZ configuration option, except that the latter only operates on the last non-dyntick-idle processor whereas the technique disclosed herein is performed for all processors. Moreover, unlike RCU_FAST_NO_HZ, the mode change will be allowed to occur even if there are pending RCU callbacks, provided none require immediate invocation and the processor is not needed for grace period advancement processing. Under this condition, callbacks that will not be ready for invocation until one or more grace periods in the future will not prevent a processor from entering a low power state. Such pending callbacks will merely be noted so that the processor can be subsequently reawakened when the callbacks become ready. This can be done by setting a per-processor callback flag (which may be given a name such as “rcu_have_callbacks”) that is cleared when the callbacks are eventually processed or when the processor leaves its low power state.

The processor will be prevented from entering a low power state only in the event that there are one or more RCU callbacks that are ready for invocation, or if the processor needs to perform an action that helps advance RCU's grace period machinery and there are also one or more pending callbacks (even if they are not ready to be invoked). In that case, the callback flush loop processing implemented by the existing Linux® RCU_FAST_NO_HZ configuration option will be performed for a specified number of passes. As described in the “Background” section above, this processing results in alternating attempts to (1) advance the RCU grace period machinery and (2) process the callbacks in a clean environment (such as the Linux® kernel's softirq context). As in the case of RCU_FAST_NO_HZ, the number of passes through the callback flush loop, as well as the hold-off period that is observed before entering the loop, may be selected using per-processor state variables. When RCU ends a grace period, a check may be performed to see if there are any other low power state processors with their rcu_have_callbacks flag set. If so, the corresponding processors may be sent interprocessor interrupts (IPIs) to force them out of their low power state to process their callbacks.

### Example Embodiment

Turning now to the figures, wherein like reference numerals represent like elements in all of the several views, FIG. 4 illustrates an example multiprocessor computing environment in which the grace period processing technique described herein may be implemented. In FIG. 4, a computing system 2 includes multiple processors 4₁, 4₂ . . . 4ₙ, a system bus 6, and a program memory 8. There are also cache memories 10₁, 10₂ . . . 10ₙ and cache controllers 12₁, 12₂ . . . 12n respectively associated with the processors 4₁, 4₂ . . . 4ₙ. A conventional memory controller 14 is again associated with the memory 8. As shown, the memory controller 14 may reside separately from processors 4₂ . . . 4ₙ (e.g., as part of a chipset). Alternatively, the memory controller 14 could be provided by plural memory controller instances respectively integrated with the processors 4₂ . . . 4ₙ (as is known in the art).

The example computing system 2 may represent any of several different types of computing apparatus. Such computing apparatus may include, but are not limited to, general purpose computers, special purpose computers, portable computing devices, communication and/or media player devices, set-top devices, embedded systems, to name but a few. The processors 4₁, 4₂ . . . 4ₙ may each be a single-core CPU device, or alternatively, could represent individual cores within a multi-core CPU device. Each CPU device embodied by any given processor 4 is operable to execute program instruction logic under the control of a software program stored in the memory 8 (or elsewhere). The memory 8 may comprise any type of tangible storage medium capable of storing data in computer readable form, including but not limited to, any of various types of random access memory (RAM), various flavors of programmable read-only memory (PROM) (such as flash memory), and other types of primary storage. The processors 4₁, 4₂ . . . 4ₙ and the memory 8 may be situated within a single computing device or node (e.g., as part of a single-node SMP system) or they may be distributed over plural nodes (e.g., as part of a NUMA system, a cluster, a cloud, etc.).

An update operation (updater) 18 may periodically execute within a process, thread, or other execution context (hereinafter “task”) on any of the processors 4₁, 4₂ . . . 4ₙ. Each updater 18 runs from program instructions stored in the memory 8 (or elsewhere) in order to periodically perform updates on a set of shared data 16 that may be stored in the shared memory 8 (or elsewhere). In FIG. 4, reference numerals 18₁, 18₂ . . . 18ₙ illustrate individual data updaters that may periodically execute on the several processors 4₁, 4₂ . . . 4ₙ. As described in the “Background” section above, the updates performed by an RCU updater can include modifying elements of a linked list, inserting new elements into the list, deleting elements from the list, and other types of operations. To facilitate such updates, the processors 4₁, 4₂ . . . 4ₙ are programmed from instructions stored in the memory 8 (or elsewhere) to implement a read-copy update (RCU) subsystem 20 as part of their processor functions. In FIG. 4, reference numbers 20₁, 20₂ . . . 20ₙ represent individual RCU instances that may periodically execute on the several processors 4₁, 4₂ . . . 4ₙ. Any given processor 4₁, 4₂ . . . 4ₙ may also periodically execute a read operation (reader) 21. Each reader 21 runs from program instructions stored in the memory 8 (or elsewhere) in order to periodically perform read operations on the set of shared data 16 stored in the shared memory 8 (or elsewhere). In FIG. 4, reference numerals 21₁, 21₂ . . . 21ₙ illustrate individual reader instances that may periodically execute on the several processors 4₁, 4₂ . . . 4ₙ. Such read operations will typically be performed far more often than updates, this being one of the premises underlying the use of read-copy update. Moreover, it is possible for several of the readers 21 to maintain simultaneous references to one of the shared data elements 16 while an updater 18 updates the same data element.

During run time, an updater 18 will occasionally perform an update to one of the shared data elements 16. In accordance the philosophy of RCU, a first-phase update is performed in a manner that temporarily preserves a pre-update view of the shared data element for the benefit of readers 21 that may be concurrently referencing the shared data element during the update operation. Following the first-phase update, the updater 18 may register a callback with the RCU subsystem 20 for the deferred destruction of the pre-update view following a grace period (second-phase update). As described in the “Background” section above, this is known as asynchronous grace period processing.

The grace period processing performed by the RCU subsystem 20 entails starting new grace periods and detecting the end of old grace periods so that the RCU subsystem 20 knows when it is safe to free stale data (or take other actions). Grace period processing further entails the management of callback lists that accumulate callbacks until they are ripe for batch processing at the end of a given grace period. The foregoing grace period processing operations may be performed by periodically running RCU subsystem instances 21₁, 21₂ . . . 21ₙ on the several processors 4₁, 4₂ . . . 4ₙ.

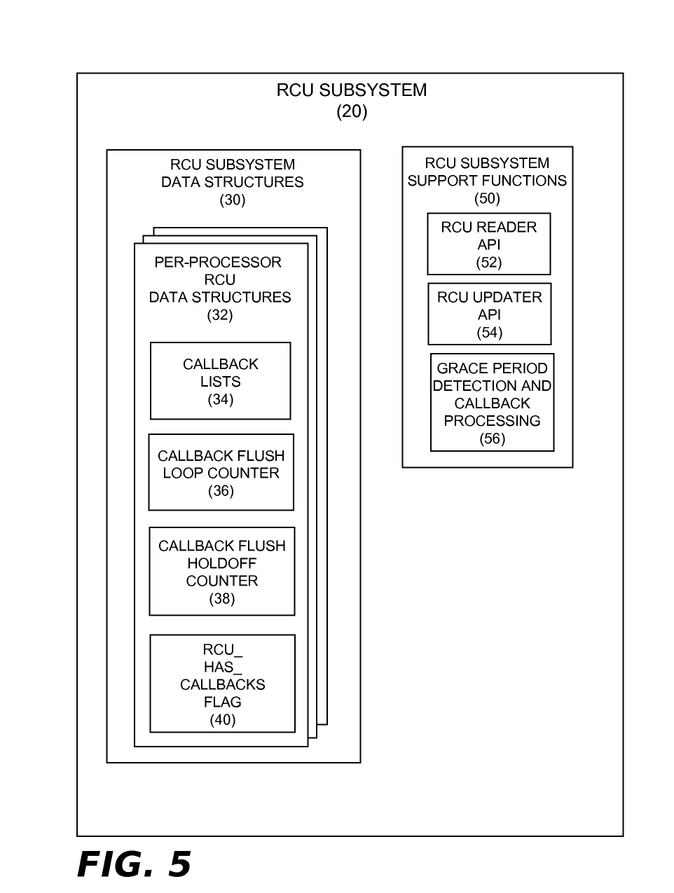

Turning now to FIG. 5, example components of the RCU subsystem 20 are shown. These components include RCU subsystem data structures 30, some of which are replicated for each of the processors 4₁, 4₂ . . . 4ₙ as per-processor RCU data structures 32. The per-processor data structures 32 include a set of per-processor callback lists 34, a callback flush loop counter 36, a callback flush loop holdoff counter 38, and an rcu_has_callbacks flag 40. The manner in which the per-processor data structures 32 are used is described in more detail below. Note that the first these data structures, i.e., the callback lists 34, represents prior art because such lists are found in many conventional RCU implementations, typically as separate list portions of a single linked list. The callback flush loop counter 36 and the callback flush loop holdoff counter 38 also represent prior art because they are used for callback flush loop processing in the Linux® RCU_FAST_NO_HZ configuration option described in the “Background” section above. The rcu_has_callbacks flag 40 is new. Although it is shown as a per-processor variable in FIG. 5, it could also be stored in a leaf rcu node structure in a hierarchical RCU implementation. It should be further noted that a production read-copy update implementation will typically include may additional data structures that are not shown in FIG. 5. A discussion of such data structures is omitted for ease of description and in order to focus attention on the particular RCU technique disclosed herein.

The components of the RCU subsystem 20 also include several RCU subsystem support functions 50, namely, an RCU reader API (Application Programming Interface) 52, an RCU updater API 54, and a set of grace period detection and callback processing functions 56.

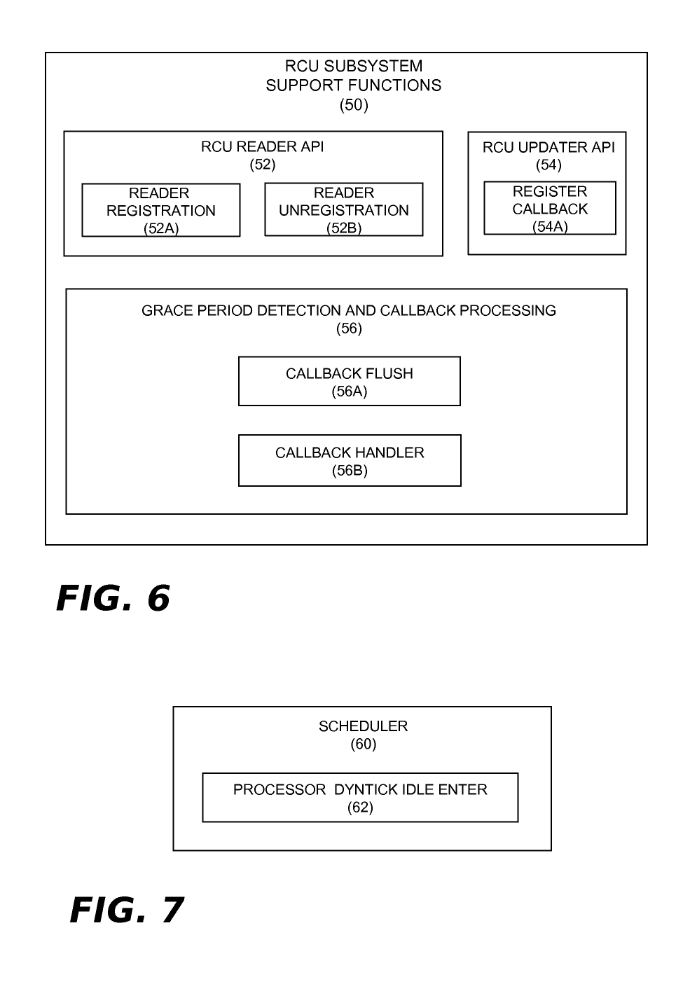

As shown in FIG. 6, the RCU reader API 52 comprises a reader registration component 52A and a reader unregistration component 52B. These components are respectively invoked by readers 21 as they enter and leave their RCU read-side critical sections. This allows the RCU subsystem 20 to track reader operations and determine when readers are engaged in RCU-protected read-side critical section processing. In an example embodiment, the reader registration component 52A and the reader unregistration component 52B may be respectively implemented using the rcu_read_lock( ) and rcu_read_unlock( ) primitives found in existing read-copy update implementations.

The RCU updater API 54 comprises a register callback component 54A. The register callback component 54A is used by updaters 18 to register a callback following a first-phase update to a shared data element 16. A call to the register callback component 54A initiates processing that places the callback on one of the RCU callback lists 34 associated with the processor 4 that runs the updater 18. This starts an asynchronous grace period so that the callback can be processed after the grace period has ended as part of second-phase update processing to remove stale data (or perform other actions). In an example embodiment, the register callback component 54A may be implemented using the existing call_rcu( ) primitive found in conventional read-copy update implementations.

In the preceding paragraph, it was noted that the register callback component 54A places a callback on one of the RCU callback lists 34 for a given processor 4. In an example embodiment, the RCU callback lists 34 for each processor 4₁, 4₂ . . . 4ₙ may comprise three separately identified lists that may be referred to as the “donelist,” the “curlist,” and the “nextlist.” Each of these callback list portions may be processed in separate stages in conjunction with separate grace periods. This allows new callbacks to safely accumulate while other callbacks are being processed. For example, at the end of a given grace period, all callbacks on the donelist will be ready for immediate invocation. Callbacks on the curlist will be invoked at the end of the next following grace period. New callbacks are placed on the nextlist and will not be ready to be invoked until the end of the second grace period that follows the current grace period. As discussed in more detail below, the component of the RCU subsystem 20 that actually processes such callbacks could be (and usually is) executed in a deferred manner in a separate environment (such as in softirq context in the Linux® kernel).

The grace period detection and callback processing functions 56 may include a callback flush component 56A and a callback handler 56B. The callback flush component 56A runs with interrupts disabled. It may be implemented using a modified version of the rcu_needs_cpu( ) function found in existing versions of the Linux® kernel that are compiled with the RCU_FAST_NO_HZ configuration option. See Linux® 3.0 source code, rcu_needs_cpu( ) function at lines 1170-1244 of Linux/kernel/rcutree_plugin.h. The callback flush component 56A is initially called from the operating system scheduler 60 when the latter attempts place one of the processors 4₁, 4₂ . . . 4ₙ in dyntick-idle mode (or some other low power state in which the scheduling clock interrupt is suppressed). The component is also called from the callback handler 56B following callback invocation in order to implement a new pass through the callback flush loop.

FIG. 7 illustrates an operating system scheduler 60 that may invoke the callback flush component 56A. The scheduler 60 includes a processor dyntick-idle enter function 62 that performs the invocation operation. The purpose of invoking the callback flush component 56A is for the scheduler 60 to determine whether a processor 4 may be safely placed in the low power state, or whether the mode switch must be deferred because the processor has RCU work to perform. In an example embodiment, the processor dyntick-idle enter function 62 may be implemented using the existing tick_nohz_stop_sched_tick( ) function found in current versions of the Linux® scheduler. See Linux® 3.0 source code, tick_nohz_stop_sched_tick( ) function at lines 251-453 of Linux/kernel/time/tick-sched.c.

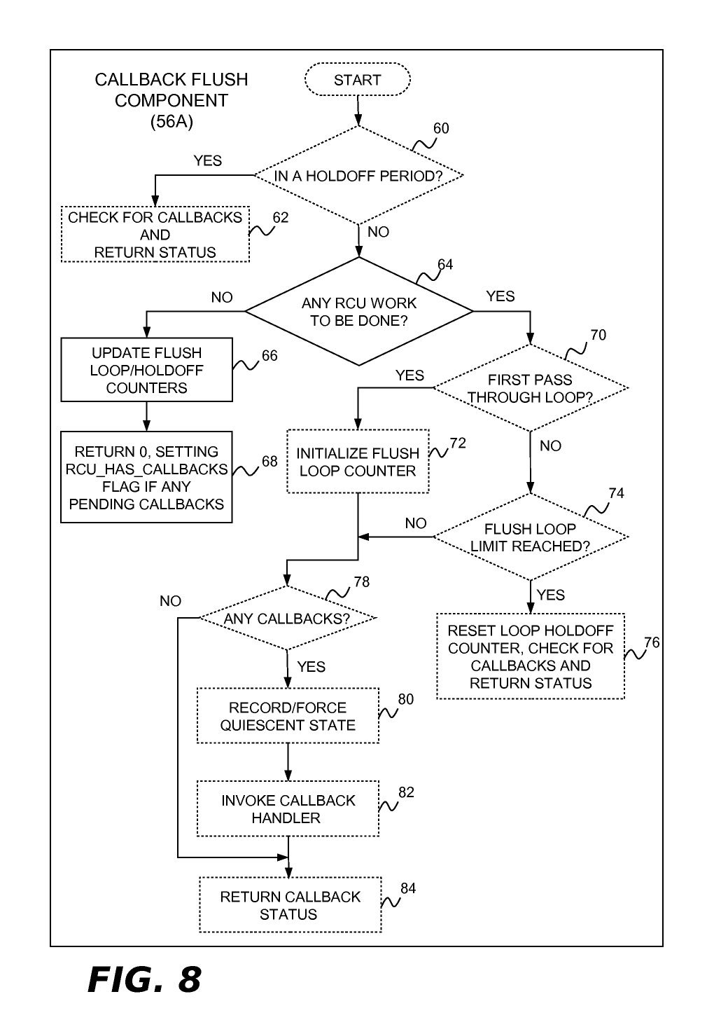

With reference now to FIG. 8, example operations that may be performed by the callback flush component 56A are shown. To assist the reader, operations that are found in the existing rcu_needs_cpu( ) function of the Linux® kernel are shown in phantom line representation. Operations that represent new modifications to the rcu_needs_cpu( ) function in accordance with the present disclosure are shown in solid line representation. The new operations comprise blocks 64, 66 and 68. These operations replace an existing portion of the rcu_needs_cpu( ) function that tests whether a current processor 4 is the last non-dyntick-idle processor, and exits the function if there are other non-dyntick-idle processors. Of these three operations, it should be noted that block 64 may be implemented using an existing read-copy update function known as rcu_pending( ) See Linux® 3.0 source code, rcu_pending( ) wrapper function at lines 1631-1641 of Linux/kernel/rcutree.c and _rcu_pending( ) work function at lines 1561-1629 of Linux/kernel/rcutree.c. The rcu_pending( ) function is normally invoked from the scheduling clock interrupt to determine if a processor has RCU work to perform in softirq context (such as invoking callbacks). It is not used in the existing RCU_FAST_NO_HZ version of the rcu_needs_cpu( ) function. As described in the “Introduction” section above, the present disclosure contemplates that the callback flush component 56A will be invoked for any processor 4 that is being considered for placement in a low power state, not just the last processor being placed in such a state.

In block 60, the holdoff counter 38 is sampled to determine if a holdoff period is in effect. If it is, a quick check is made of the current processor's callback lists 34 in block 62. This status (callbacks or no callbacks) is then returned to caller. The caller, i.e., the processor dyntick idle enter function 62 run by the scheduler 60, will typically refrain from placing the processor 4 in a low power mode if the return status indicates there are callbacks, but will proceed with the low power mode switch if there are no callbacks. In block 64, a check is made whether the current processor 4 has any RCU work to be done, meaning that there callbacks requiring invocation or the processor needs to perform some action to advance the RCU subsystem's grace period machinery. As described above, the operation of block 64 may be implemented using the rcu_pending( ) function found in current RCU implementations in the Linux® kernel. Block 60 may thus check whether (1) there are any callbacks on the donelist portion of the processor's callback lists 34 (i.e., callbacks ready for immediate invocation), (2) the processor is unaware of the beginning or end of a grace period and needs to update its state accordingly, (3) the processor needs to inform the RCU subsystem 20 of a recent passage through a quiescent state, (4) the processor needs another grace period but the RCU subsystem 20 has gone idle, and (5) a grace period has lasted too long such that other processors may need to be awakened. If block 64 determines that none of these conditions is present, it means that the processor 4 does not have any RCU callbacks that are ready for invocation and the RCU subsystem 20 does not require any grace period advancement processing from the current processor 4. In that case, the processor 4 may be safely placed in a low power mode. In preparation for this mode switch, block 66 updates the flush loop counter 36 and the holdoff counter 38. This updating entails setting the flush loop counter 36 to a value signifying the end of flush loop processing, and setting the holdoff counter 38 to a value signifying that no holdoff period is in effect. In block 68, the processor's rcu_has_callbacks flag 40 is set if there are any callbacks that not ready for immediate invocation, but will need to be invoked following the end of a future grace period. This would include callbacks that are on the curlist or nextlist portions of the processor's callback lists 34. A return value of zero (0) is then returned to the caller so that the processor 4 can be placed in a low power state even though it may have callbacks that are awaiting a future grace period. If the rcu_have_callbacks flag 40 is set, the processor 4 will be subsequently awakened to process these callbacks. Once all such callbacks have been processed, the rcu_have_callbacks flag 40 can be cleared. These operations are discussed in more detail below in connection with the callback handler 56B.

If block 64 detected that the current processor 4 has RCU work to be done, it means that either the processor 4 has one or more RCU callbacks that are ready for invocation or the RCU subsystem 20 needs the processor to perform grace period advancement processing. In that case, block 70 checks whether this is the first pass through the callback flush loop. If so, block 72 initializes the flush loop counter. If this is not the first pass through the callback flush loop, block 74 decrements the processor's flush loop counter 36 and tests whether the flush loop limit has been reached. If the limit has been reached, block 76 resets the processor's holdoff counter 38, checks for callbacks, and returns the callback status (callbacks or no callbacks) to the caller. Following block 72, or if the flush loop limit was not detected in block 74, a check for pending callbacks is made in block 78. If any callbacks are detected (regardless whether or not they are ready for invocation), block 80 records a quiescent state for the current processor and attempts to force a quiescent state on any other processors that may be delaying the end of a grace period. In block 82, a request is made for deferred invocation of the callback handler 56B in softirq context (or in some other safe environment). Following block 82, or if no callbacks were detected in block 78, block 84 returns the processor's callback status (callbacks or no callbacks) to the caller. If the “yes” path was taken from block 78, the return status will indicate the presence of RCU callbacks and the caller will typically refrain from placing the processor 4 in a low power state. If the “no” path was taken from block 78, the return status will indicate that there are no callbacks and the caller will typically allow the processor 4 to be placed into a low power state. Note that this mode switch is allowed even though the RCU subsystem 20 needs the processor to perform grace period advancement processing. This is acceptable because the RCU subsystem 20, by design, will interpret the processor 4 being in a low power mode as tantamount to the processor having performed such actions.

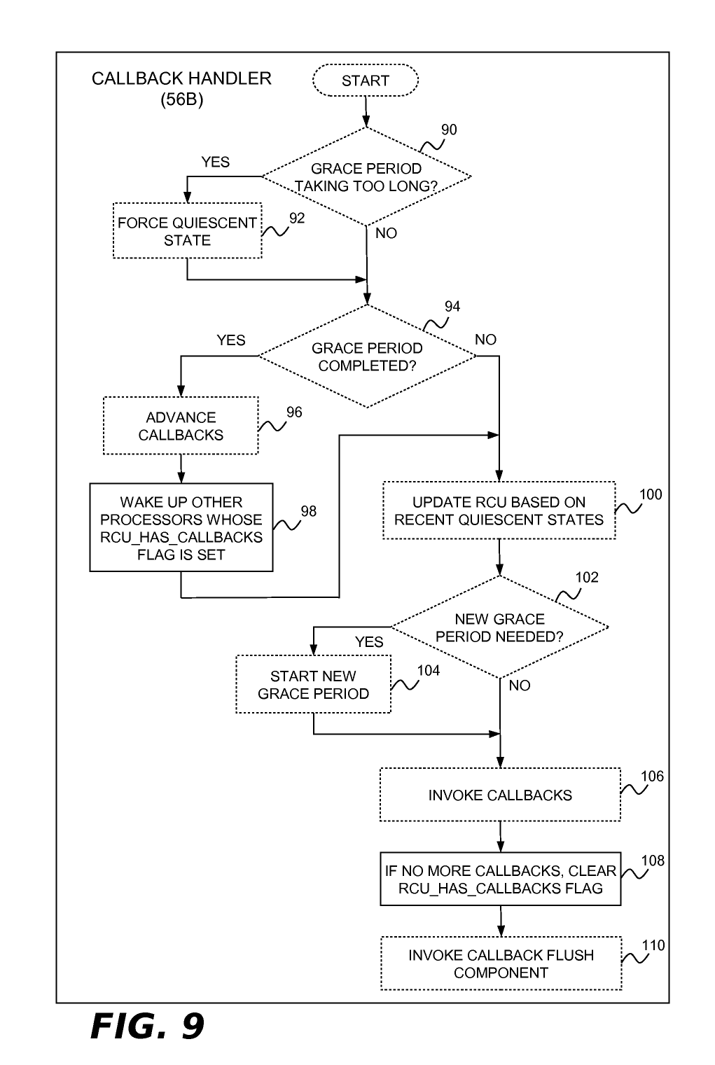

With reference now to FIG. 9, example operations that may be performed by the callback handler component 56B are shown. This component may be implemented using a modified version of the “rcu_process_callbacks( )” function found in existing versions of the Linux Kernel® that are compiled with the RCU_FAST_NO_HZ configuration option. See Linux® 3.0 source code, rcu_process_callbacks( ) wrapper function at lines 1389-1415 of Linux/kernel/rcutree.c and _rcu_process_callbacks( ) work function at lines 1351-1387 of Linux/kernel/rcutree.c. As mentioned in the paragraph above, the callback handler component 56B is invoked in softirq context following a request for such invocation in block 82 of FIG. 8. The actual commencement of the callback handler component 56B will not occur until some time following block 84 of FIG. 8 (in which the callback flush component 56A returns to its caller). The job of the callback handler component 56B is to invoke any callbacks that are ready for immediate invocation and advance any callbacks that may not be ready for immediate invocation. The callback handler component 56B also advances the RCU subsystem's grace period machinery. To assist the reader, operations of the callback handler component 56B that are found in the existing rcu_process_callbacks( ) function of the Linux® kernel are shown in phantom line representation. Operations that represent new modifications to the rcu_process_callbacks( ) function in accordance with the present disclosure are shown in solid line representation. The new operations comprise blocks 98 and 108.

In block 90, a check is made whether the current grace period is taking too long. If it is, block 92 attempts to force a quiescent state on any processors that may be delaying the end of the grace period. Following block 92, or if the “no” path is taken from block 90, block 94 checks whether the current grace period has completed. If it has, block 96 advances all callbacks on the processor's callback lists 34. Block 98 then checks the rcu_has_callbacks flag 40 of all other processors and wakes up those processors whose flag is set. This may be done by sending such processors an interprocessor interrupt (IPI). As discussed in connection with the callback flush component 56A, this will awaken any processor that was placed in a low power state despite having pending callbacks following block 68 of FIG. 8. These processors will then have an opportunity to process their callbacks, clear their rcu_has_callbacks flag 40, and return to low power mode.

Following block 98, or if the “no”path is taken from block 94, block 100 updates the grace period machinery of the RCU subsystem 20 by reporting any recent quiescent states experienced by the current processor 4. In block 102, a check is made whether a new grace period is needed by the current processor 4 because none is currently in progress. If so, block 104 starts the new grace period. Blocks 102 and 104 are implemented with interrupts disabled. Following block 104, or if the “no” path is taken from block 102, block 106 invokes all callbacks of the processor 4 that are ready for immediate invocation. Block 108 then clears the processor's rcu_has_callbacks flag if there are no more callbacks on the processor's callback lists 34. In block 110, the callback handler 56B re-invokes the callback flush component 56A (with interrupts disabled) to start a new pass through the callback flush loop. When this next pass of the callback flush component 56A completes, it will again request invocation of the callback handler 56B, albeit in a different softirq context than the first invocation of the callback handler 56B. This loop processing continues until the callback flush loop limit defined by the flush loop counter 38 is reached or until all of the processor's callbacks are invoked, whichever occurs sooner. In this way, repeated attempts could be made in an attempt to flush the processor's callbacks. At some point, the scheduler 60 will again invoke its processor dyntick idle enter function 62 when returning from softirq context to idle. This will cause the callback flush component 56A to again be invoked. If the previous round of callback flush loop processing is successful, the processor 4 can be placed in a low power state without impacting RCU. If the callback flush loop processing was not successful, the processor 4 will not be placed in a low power state. However, a next round of callback flush processing will be performed.

Accordingly, a technique for has been disclosed for implementing read-copy update in an energy efficient manner for light workloads running on systems with many processors, and in other environments. It will be appreciated that the foregoing concepts may be variously embodied in any of a data processing system, a machine implemented method, and a computer program product in which programming logic is provided by one or more machine-useable storage media for use in controlling a data processing system to perform the required functions. Example embodiments of a data processing system and machine implemented method were previously described in connection with FIGS. 4-9. With respect to a computer program product, digitally encoded program instructions may be stored on one or more computer-readable data storage media for use in controlling a computer or other digital machine or device to perform the required functions. The program instructions may be embodied as machine language code that is ready for loading and execution by the machine apparatus, or the program instructions may comprise a higher level language that can be assembled, compiled or interpreted into machine language. Example languages include, but are not limited to C, C++, assembly, to name but a few. When implemented on a machine comprising a processor, the program instructions combine with the processor to provide a particular machine that operates analogously to specific logic circuits, which themselves could be used to implement the disclosed subject matter.

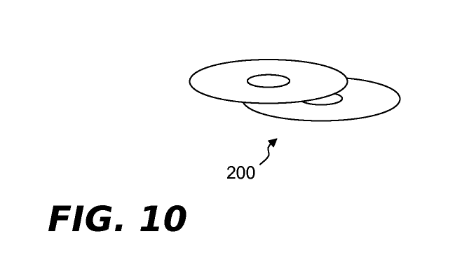

Example data storage media for storing such program instructions are shown by reference numerals 8 (memory) and 10 (cache) of the multiprocessor system 2 of FIG. 4. The system 2 may further include one or more secondary (or tertiary) storage devices (not shown) that could store the program instructions between system reboots. A further example of media that may be used to store the program instructions is shown by reference numeral 200 in FIG. 10. The media 200 are illustrated as being portable optical storage disks of the type that are conventionally used for commercial software sales, such as compact disk-read only memory (CD-ROM) disks, compact disk-read/write (CD-R/W) disks, and digital versatile disks (DVDs). Such media can store the program instructions either alone or in conjunction with an operating system or other software product that incorporates the required functionality. The data storage media could also be provided by portable magnetic storage media (such as floppy disks, flash memory sticks, etc.), or magnetic storage media combined with drive systems (e.g. disk drives). As is the case with the memory 8 and the cache 10 of FIG. 4, the storage media may be incorporated in data processing platforms that have integrated random access memory (RAM), read-only memory (ROM) or other semiconductor or solid state memory. More broadly, the storage media could comprise any electronic, magnetic, optical, infrared, semiconductor system or apparatus or device, or any other tangible entity representing a machine, manufacture or composition of matter that can contain, store, communicate, or transport the program instructions for use by or in connection with an instruction execution system, apparatus or device, such as a computer. For all of the above forms of storage media, when the program instructions are loaded into and executed by an instruction execution system, apparatus or device, the resultant programmed system, apparatus or device becomes a particular machine for practicing embodiments of the method(s) and system(s) described herein.

Although various example embodiments have been shown and described, it should be apparent that many variations and alternative embodiments could be implemented in accordance with the disclosure. It is understood, therefore, that the invention is not to be in any way limited except in accordance with the spirit of the appended claims and their equivalents.

What is claimed is:

1. In a multiprocessor computing system having two or more processors operatively coupled to one or more memory devices and implementing a read-copy update (RCU) subsystem, a method for determining if a processor may be placed in low power state, comprising:
determining whether said processor has any RCU callbacks that are ready for invocation or said RCU subsystem requires grace period advancement processing from said processor; and
placing said processor in a low power state if either:
a first condition holds wherein said processor has one or more pending RCU callbacks, but does not have any RCU callbacks that are ready for invocation and said RCU subsystem does not require grace period advancement processing from said processor; or
a second condition holds wherein said processor does not have any pending RCU callbacks.

2. The method of claim 1, further including setting a callback flag when placing said processor in a low power state when said first condition holds in order to note that said processor has one or more pending RCU callbacks.

3. The method of claim 2, further including performing callback flush loop processing to invoke or advance RCU callbacks if a third condition holds wherein said processor has one or more pending RCU callbacks, and such callbacks are ready for invocation or said RCU subsystem requires grace period advancement processing from said processor.

4. The method of claim 3, further including clearing said callback flag if it has been set for said processor and if said callback flush loop processing is performed and said processor has no more callbacks.

5. The method of claim 4, further including checking at the end of an RCU grace period whether other processors are in a low power state and have said callback flag set, and if so, waking said other processors from their low power state so that their callbacks may be processed.

6. The method of claim 1, wherein said method is performed for each processor in said system when attempting to place said processors in a low power state.

7. The method of claim 3, wherein said callback flush loop processing is repeated for a predetermined loop count or until said first condition or said second condition is reached.

8. A multiprocessor system, comprising:
two or more processors;
a memory coupled to said processors, said memory including a computer useable medium tangibly embodying at least one program of instructions executable by said processors to implement a read-copy update (RCU) subsystem and to perform operations for determining if a processor may be placed in low power state, said operations comprising:
determining whether said processor has any RCU callbacks that are ready for invocation or said RCU subsystem requires grace period advancement processing from said processor; and
placing said processor in a low power state if either:
a first condition holds wherein said processor has one or more pending RCU callbacks, but does not have any RCU callbacks that are ready for invocation and said RCU subsystem does not require grace period advancement processing from said processor; or
a second condition holds wherein said processor does not have any pending RCU callbacks.

9. The system of claim 8, wherein said operations further include setting a callback flag when placing said processor in a low power state when said first condition holds in order to note that said processor has one or more pending RCU callbacks.

10. The system of claim 9, further including performing callback flush loop processing to invoke or advance RCU callbacks if a third condition holds wherein said processor has one or more pending RCU callbacks, and such callbacks are ready for invocation or said RCU subsystem requires grace period advancement processing from said processor.

11. The system of claim 10, wherein said operations further include clearing said callback flag if it has been set for said processor if said callback flush loop processing is performed and said processor has no more callbacks.

12. The system of claim 11, wherein said operations further include checking at the end of an RCU grace period whether other processors are in a low power state and have said callback flag set, and if so, waking said other processors from their low power state so that their callbacks may be processed.

13. The system of claim 8, wherein said operations are performed for each processor in said system when attempting to place said processors in a low power state.

14. The system of claim 10, wherein said callback flush loop processing is repeated for a predetermined loop count or until said first condition or said second condition is reached.

15. A computer program product, comprising:
one or more machine-useable storage media;
program instructions provided by said one or more media for programming a multiprocessor data processing platform to implement a read-copy update (RCU) subsystem and to perform operations for determining if a processor may be placed in low power state, said operations comprising:
determining whether said processor has any RCU callbacks that are ready for invocation or said RCU subsystem requires grace period advancement processing from said processor; and
placing said processor in a low power state if either:
a first condition holds wherein said processor has one or more pending RCU callbacks, but does not have any RCU callbacks that are ready for invocation and said RCU subsystem does not require grace period advancement processing from said processor; or
a second condition holds wherein said RCU subsystem does require grace period advancement processing from said processor, but said processor does not have any pending RCU callbacks.

16. The computer program product of claim 15, wherein said operations further include setting a callback flag when placing said processor in a low power state when said first condition holds in order to note that said processor has one or more pending RCU callbacks.

17. The computer program product of claim 16, further including performing callback flush loop processing to invoke or advance RCU callbacks if a third condition holds wherein said processor has one or more pending RCU callbacks, and such callbacks are ready for invocation or said RCU subsystem requires grace period advancement processing from said processor.

18. The computer program product of claim 17, wherein said operations further include clearing said callback flag if it has been set for said processor and if said callback flush loop processing is performed and said processor has no more callbacks.

19. The computer program product of claim 18, wherein said operations further include checking at the end of an RCU grace period whether other processors are in a low power state and have said callback flag set, and if so, waking said other processors from their low power state so that their callbacks may be processed.

20. The computer program product of claim 15, wherein said operations are performed for each processor in said system when attempting to place said processors in a low power state.

21. The computer program product of claim 17, wherein said callback flush loop processing is repeated for a predetermined loop count or until said first condition or said second condition is reached.
